(19) United States
(12) Patent Application Publication
(10) Pub. No.: US 2026/0284516 A1
(43) Pub. Date: Sep. 24, 2026

(54) CHIP DISPENSER AND METHOD OF OPERATING THE SAME

(71) Applicant: CLONIX CO., LTD., Seongnam-si (KR)

(72) Inventor: Seung Lee NAM, Seongnam-si (KR)

(21) Appl. No.: 19/685,900

(22) Filed: May 22, 2026

Related U.S. Application Data
(63) Continuation of application No. PCT/KR2025/008410, filed on Jun. 18, 2025.

(30) Foreign Application Priority Data
Jun. 19, 2024 (KR) 10-2024-0079864

(51) Int. Cl. A63F 11/00

(52) U.S. Cl. CPC A63F 11/0002; A63F 2011/0006

(57) ABSTRACT

A chip dispenser and method of operating the same are provided. The chip dispenser includes a chip case and a dispensing device. The chip case includes a base unit and a cover unit coupled to define cylindrical accommodating areas for receiving chips, and includes a chip discharge port and a pusher inlet. The dispensing device includes a pusher member and a driving unit configured to linearly reciprocate the pusher member. In operation, the chip case is mounted on the dispensing device, and the pusher member enters the pusher inlet to push a chip inside the chip case so that the chip is discharged through the chip discharge port. A sensor unit may detect the position of the pusher member, and the driving unit may be controlled so that one chip is discharged per cycle. The dispenser improves loading workability and accurate chip dispensing while reducing chip damage.

### CROSS-REFERENCE TO RELATED APPLICATION

This application claims priority from and the benefit of Korean Patent Application No. 10-2024-0079864 filed on Jun. 19, 2024, which are hereby incorporated by reference in its entirety.

### BACKGROUND

### Field

The present invention relates to a mechanical device, components thereof, and related methods, and more particularly to a dispenser, components thereof, and related methods.

### Related Art

A device for dispensing chips or coins may be used in a casino facility, a gaming hall, a financial institution, or the like.

In existing chip dispensers, there may be included a structure, which may be a kind of chip storage container, in which a plurality of tubular cylinders each having an accommodating space therein are arranged adjacent to one another side by side, and chips may be discharged therefrom in a state in which the chips are stored in the tubular cylinders. However, since the tubular cylinders are configured such that chips are introduced through openings at ends thereof, the chips have to be inserted one by one for each type, resulting in poor workability, increased working time, and increased costs.

In addition, existing chip dispensers have a drawback in that chips are readily damaged during discharge. In the process of moving chips made of plastic or the like in a horizontal direction through a predetermined passage, the chips may be readily damaged by friction. Chips used in casinos and the like, which may be converted into considerably high values depending on their types, may be manufactured very precisely. If the chips are damaged, it may be necessary to replace the chips periodically, thereby increasing maintenance costs.

### SUMMARY

An object of the present invention is to provide a chip dispenser capable of greatly improving workability in chip loading and reducing labor and time consumption.

Another object of the present invention is to provide a chip dispenser capable of accurately and easily discharging chips while suppressing or minimizing damage to the chips.

Another object of the present invention is to provide components of the chip dispenser.

Another object of the present invention is to provide a method of operating the chip dispenser.

The problems to be solved by the present invention are not limited to the above-mentioned problems, and other problems not mentioned will be clearly understood by those skilled in the art from the following description.

According to embodiments of the present invention for achieving the foregoing objects, there is provided a chip dispenser for dispensing chips, including: a chip case including a base unit and a cover unit capable of being coupled to the base unit, wherein the base unit and the cover unit are configured to define a cylindrical accommodating area, a plurality of chips are accommodated within the accommodating area, and the chip case has a chip discharge port for discharging the chips and a pusher inlet; and a dispensing device on which the chip case is mounted, the dispensing device including a pusher member capable of entering and exiting the pusher inlet and a driving unit for driving the pusher member, wherein the driving unit is configured to enable linear reciprocating motion of the pusher member, wherein, in a state where the chip case is mounted on the dispensing device, the pusher member is inserted into the pusher inlet and pushes a chip inside the chip case so that the chip is discharged through the chip discharge port.

A hinge member may be provided between the base unit and the cover unit, and the base unit and the cover unit may be configured to be opened and closed in a pivoting manner by the hinge member.

The base unit and the cover unit may be configured to be coupled and opened and closed in a sliding manner.

The pusher inlet may be provided at a lower end of one of the base unit and the cover unit, and the chip discharge port may be provided at a lower end of the other one of the base unit and the cover unit.

The pusher inlet and the chip discharge port may be provided at a lower end of the base unit.

A plurality of first accommodating grooves parallel to each other may be provided in the base unit, and a plurality of second accommodating grooves parallel to each other may be provided in the cover unit, and each of the plurality of first accommodating grooves and a corresponding one of the plurality of second accommodating grooves may form the cylindrical accommodating area.

The cover unit may be configured to cover an open front area of the base unit.

The driving unit may include a motor member for rotating a rotation shaft member, and the dispensing device may include a power transmission structure for converting rotational motion of the rotation shaft member into linear reciprocating motion of the pusher member.

The power transmission structure may include a rotation plate coupled to the rotation shaft member and rotated together therewith; a first strut part coupled to the rotation plate; a second strut part coupled to the pusher member; and a connection part disposed to connect the first and second strut parts.

The dispensing device may include a support structure, and the support structure may have a first guide hole for guiding movement of the pusher member and a second guide hole for guiding movement of the second strut part.

The dispensing device may further include a sensor unit for detecting a position of the pusher member.

The dispensing device may be configured such that, in a state where the pusher member is detected by the sensor unit, the position of the pusher member is moved by operation of the driving unit and accordingly the pusher member enters a state in which it is not detected by the sensor unit, and when the position of the pusher member moves and the pusher member is again detected by the sensor unit, operation of the driving unit is stopped so that one chip is discharged per cycle.

According to embodiments of the present invention, it is possible to implement a chip dispenser capable of greatly improving workability in chip loading and reducing labor and time consumption. In addition, according to embodiments of the present invention, it is possible to implement a chip dispenser capable of accurately and easily discharging chips while suppressing or minimizing damage to the chips.

Accordingly, by using the chip dispenser according to embodiments, it is possible to improve workability to reduce related costs and time, ensure accurate dispensing operation, and further reduce maintenance costs.

In addition, a predetermined quantity of chips can be efficiently loaded using the chip case, and since the chip case and the driving unit for discharging chips are separated, the division of work between a department managing chips and a department managing the chip dispenser while replacing the chip case can be clarified.

However, the effects of the present invention are not limited to the above effects and may be expanded in various manners without departing from the technical spirit and scope of the present invention.

### BRIEF DESCRIPTION OF DRAWINGS

FIGS. 1, 2, 3, and 4 are perspective views exemplarily illustrating a chip case applicable to a chip dispenser according to an embodiment of the present invention.

FIG. 5 is a photographic image exemplarily illustrating a chip case according to an embodiment of the present invention.

FIG. 6 is a perspective view exemplarily illustrating a chip case applicable to a chip dispenser according to another embodiment of the present invention.

FIG. 7 illustrates a modified example of the first accommodating groove (G11) shown in FIG. 6.

FIG. 8 is a view illustrating the base unit (11) to which the first accommodating grooves (G11) shown in FIG. 7 are applied.

FIGS. 9, 10, 11, and 12 are perspective views exemplarily illustrating a dispensing device applicable to a chip dispenser according to an embodiment of the present invention.

FIGS. 13 and 14 are photographic images exemplarily illustrating a dispensing device according to an embodiment of the present invention.

FIGS. 15, 16, 17, and 18 are perspective views exemplarily illustrating a chip dispenser including a chip case and a dispensing device coupled to each other according to an embodiment of the present invention.

FIG. 19 is a view illustrating a discharge port sensor (260) that may be included in the dispensing device (200).

### DETAILED DESCRIPTION

Hereinafter, embodiments of the present invention will be described in detail with reference to the accompanying drawings.

The embodiments of the present invention described below are provided to explain the present invention more clearly to those having ordinary skill in the art, and the scope of the present invention is not limited by the following embodiments, and the following embodiments may be modified in various other forms.

Terms used in the present specification are used to describe particular embodiments and are not intended to limit the present invention. As used in the present specification, singular terms may include plural forms unless the context clearly indicates otherwise. In addition, the terms “comprise” and/or “comprising” as used in the present specification specify the presence of stated features, steps, numbers, operations, members, elements, and/or groups thereof, but do not preclude the presence or addition of one or more other features, steps, numbers, operations, members, elements, and/or groups thereof. In addition, the term “connected” as used in the present specification encompasses not only a state in which certain members are directly connected, but also a state in which they are indirectly connected with another member interposed therebetween.

Further, when a member is described in the present specification as being located “on” another member, this includes not only a case where the member is in contact with the other member, but also a case where another member is present between the two members. The term “and/or” as used in the present specification includes any one of the listed items and all combinations of one or more thereof. In addition, degree terms such as “about” and “substantially” used in the present specification are used in the sense of a numerical or qualitative range corresponding or close to the stated value or degree, taking into account inherent manufacturing and material tolerances, and are used to prevent an infringer from unfairly exploiting the disclosure in which exact or absolute values are recited merely to aid understanding of the present application.

Hereinafter, embodiments of the present invention will be described in detail with reference to the accompanying drawings. Sizes or thicknesses of regions or parts shown in the accompanying drawings may be somewhat exaggerated for clarity of the specification and convenience of description. Throughout the detailed description, the same reference numerals denote the same elements.

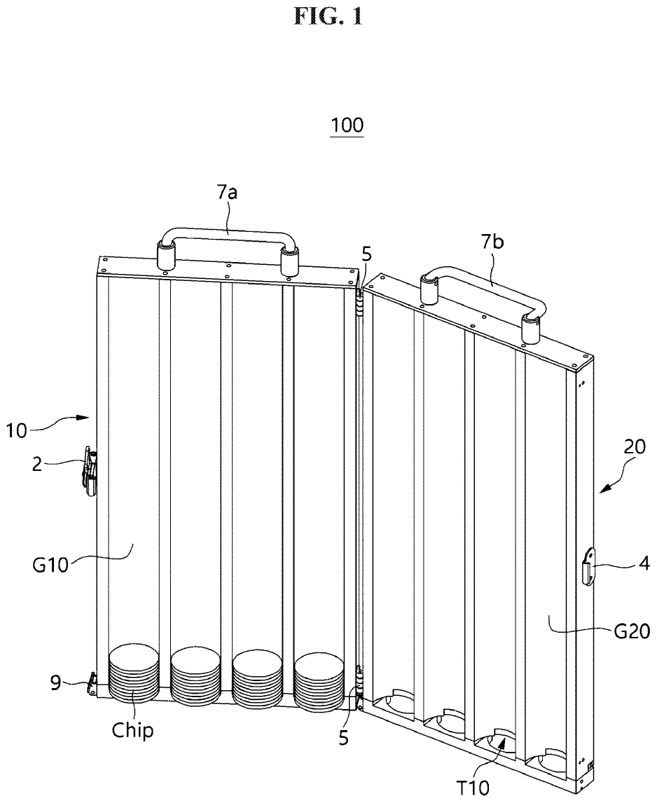

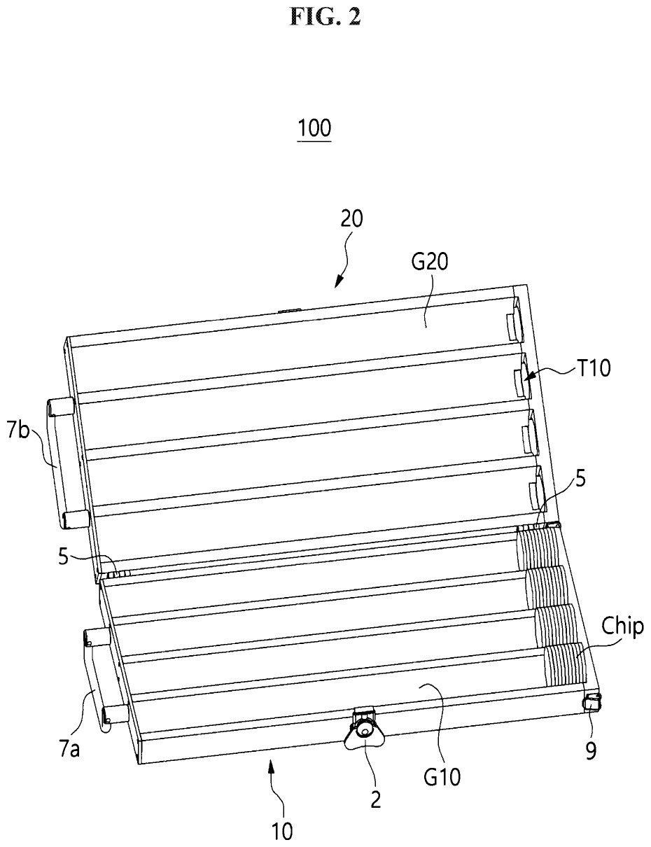

FIGS. 1, 2, 3, and 4 are perspective views exemplarily illustrating a chip case (100) applicable to a chip dispenser according to an embodiment of the present invention.

Referring to FIGS. 1, 2, 3, and 4, the chip case (100) may also be referred to as a chip storage container or chip cassette for storing chips. Here, the “chip” may be a coin-shaped chip used in a casino facility, a gaming hall, or the like. Alternatively, the “chip” may be a coin or an item corresponding or similar thereto, having a shape similar to that of a general chip. Accordingly, in the present specification, “chip” may be a term encompassing general chips, coins, and the like. The “chip” may be an object to be dispensed.

The chip case (100) may include a base unit (10) and a cover unit (20) coupled to, or capable of being coupled to, the base unit (10). The cover unit (20) may be configured to cover an open front area of the base unit (10). The base unit (10) and the cover unit (20) may be configured to define a cylindrical accommodating area, and a plurality of chips may be accommodated in the accommodating area. A plurality of cylindrical accommodating areas may be arranged parallel to one another, for example, in a row.

According to one embodiment, a plurality of first accommodating grooves (G10) parallel to each other may be provided in the base unit (10), and a plurality of second accommodating grooves (G20) parallel to each other may be provided in the cover unit (20). Each of the plurality of first accommodating grooves (G10) and a corresponding one of the plurality of second accommodating grooves (G20) may form the cylindrical accommodating area. When the chip dispenser according to the embodiment is used, the plurality of cylindrical accommodating areas may be vertically arranged. The cylindrical accommodating area may have a cylindrical shape.

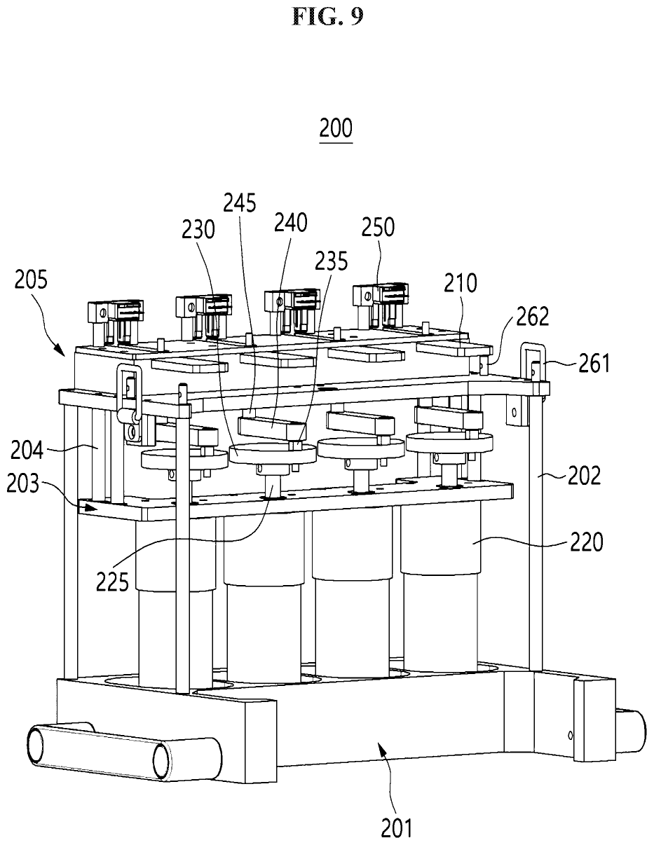

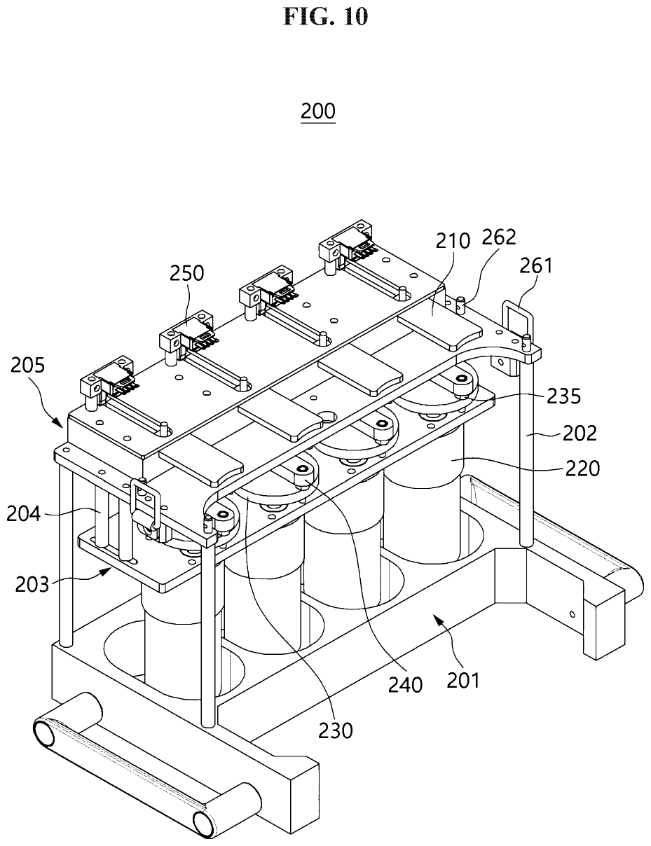

The chip case (100) may have a chip discharge port (T10) for discharging the chips and a pusher inlet (N10). Here, the pusher inlet (N10) may be an area, which may be a type of opening, into which a pusher member (210 of FIGS. 9 to 11), to be described later, is inserted. In other words, the pusher member may enter and exit through the pusher inlet (N10). The pusher inlet (N10) may communicate with a lower side region of the cylindrical accommodating area described above, and the chip discharge port (T10) may also communicate with a lower side region of the cylindrical accommodating area. As the pusher member is inserted into the pusher inlet (N10) and pushes a chip inside the chip case (100), the chip may be discharged through the chip discharge port (T10).

According to one embodiment, the pusher inlet (N10) may be provided at a lower end of one of the base unit (10) and the cover unit (20) or an area adjacent thereto, and the chip discharge port (T10) may be provided at a lower end of the other one of the base unit (10) and the cover unit (20) or an area adjacent thereto. In this embodiment, the chip discharge port (T10) may be provided at a lower end of the cover unit (20) or an area adjacent thereto, and the pusher inlet (N10) may be provided at a lower end of the base unit (10) or an area adjacent thereto. A plurality of chip discharge ports (T10) and a plurality of corresponding pusher inlets (N10) may be provided.

According to one embodiment, a lower end of the cover unit (20) may have a recessed shape at the chip discharge port (T10) portion. For example, a concave recessed portion having a semicircular shape or a similar shape may be provided at the chip discharge port (T10) portion of the lower end of the cover unit (20), and, by the recessed portion, part of a lower surface of the lowermost chip accommodated in the accommodating area may be exposed. Accordingly, friction during discharge of the chip may be further reduced, and the chip may be discharged more easily. The recessed portion may be regarded as being included in the chip discharge port (T10).

According to one embodiment, at least one hinge member (5) may be provided between the base unit (10) and the cover unit (20). The base unit (10) and the cover unit (20) may be connected to each other by the hinge member (5). The base unit (10) and the cover unit (20) may be configured to be opened and closed in a pivoting manner by the hinge member (5). That is, the cover unit (20) may pivot about the hinge member (5) as a rotation center so as to cover the open front area of the base unit (10). Such a chip case (100) may be referred to as a hinge-type case.

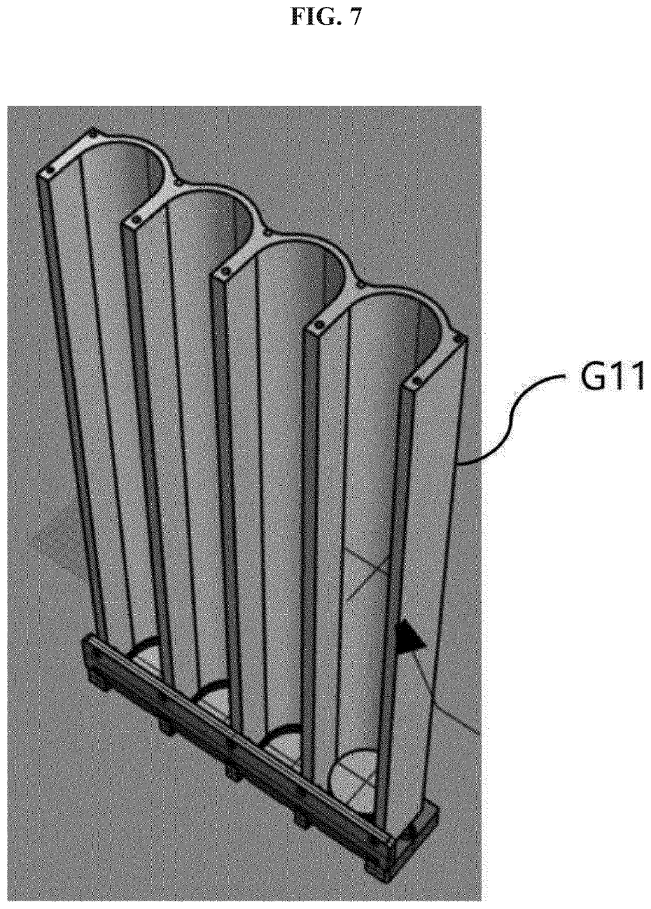

According to one embodiment, a plurality of insertion holes (h10) may be provided in a lower surface of the chip case (100). The plurality of insertion holes (h10) may be provided in a lower surface of the base unit (10) and a lower surface of the cover unit (20). The plurality of insertion holes (h10) may be holes into which a plurality of protrusions (262 of FIGS. 7, 8, and 9) of the dispensing device to be described later are inserted. As the protrusions are inserted into the insertion holes (h10), alignment between the chip case (100) and the dispensing device may be facilitated.

According to one embodiment, a fastening element (2) may be provided on an outer side surface of the base unit (10), and a corresponding fastening element (4) may be provided on an outer side surface of the cover unit (20). In a state in which the cover unit (20) covers the base unit (10), the fastening element (2) and the corresponding fastening element (4) may be fastened to each other. If necessary, a locking device (fixing device) (not shown) for fixing such fastening may be further provided. The positions, structures, fastening principles, and the like of the fastening element (2) and the corresponding fastening element (4) are not limited to those shown and may be varied in various ways.

According to one embodiment, fastening members (9) may be provided on both side surfaces of the chip case (100). The fastening members (9) may be disposed on both side surfaces of the chip case (100) in a state in which the cover unit (20) covers the base unit (10). The fastening members (9) may be fastened to corresponding fastening members (261 of FIGS. 7, 8, 9, and 10) of the dispensing device to be described later. Accordingly, firm fastening may be achieved between the chip case (100) and the dispensing device.

According to one embodiment, handle units (7a, 7b) may be provided on upper surfaces of at least one of the base unit (10) and the cover unit (20). By way of non-limiting example, a first handle unit (7a) may be provided on an upper surface of the base unit (10), and a second handle unit (7b) may be provided on an upper surface of the cover unit (20). In a state in which the cover unit (20) covers the base unit (10), the first and second handle units (7a, 7b) may constitute a single handle.

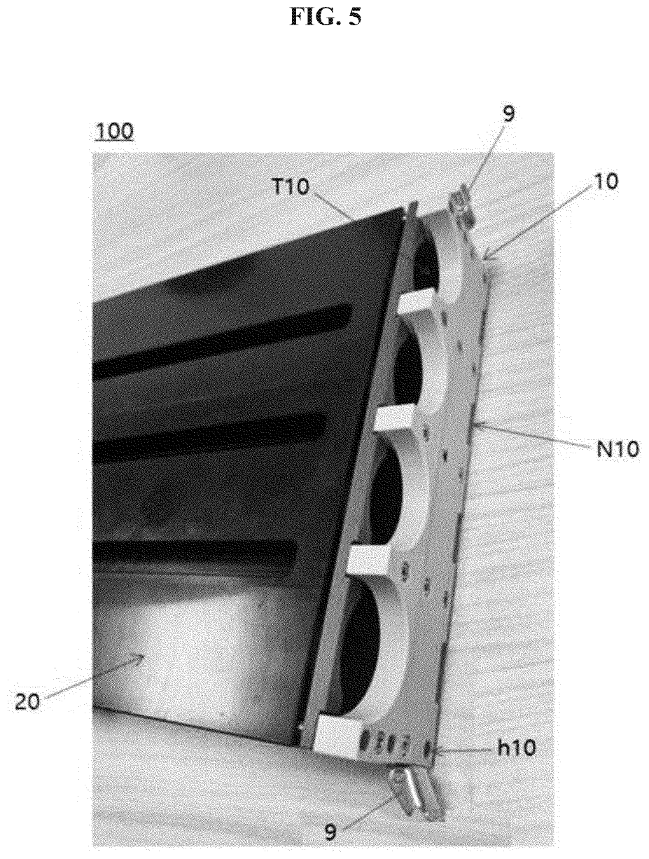

According to embodiments of the present invention, for example, in a state in which the chip case (100) is opened and laid down, a plurality of chips may be aligned and inserted into the first accommodating grooves (G10), and after the plurality of first accommodating grooves (G10) are filled with the plurality of chips, the cover unit (20) may be closed so as to cover the open front area of the base unit (10). Accordingly, workability in chip loading can be greatly improved, and labor and time consumption can be reduced. FIG. 5 is a photographic image exemplarily illustrating the chip case (100) according to an embodiment of the present invention.

Referring to FIG. 5, the structure of the chip case (100) in a state in which the base unit (10) is covered with the cover unit (20) can be seen. The reference numerals indicated in FIG. 5 may be the same as those described with reference to FIGS. 1, 2, 3, and 4. As mentioned above, a pusher member (210 of FIGS. 7, 8, and 9) may be inserted into the pusher inlet (N10) and push a chip inside the chip case (100), namely the lowermost chip, so that the chip may be discharged through the chip discharge port (T10).

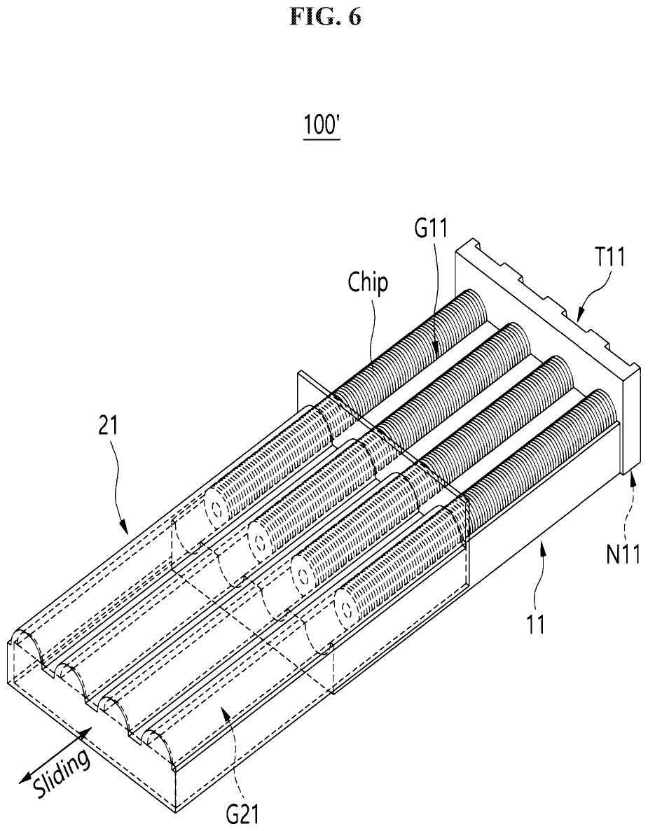

FIG. 6 is a perspective view exemplarily illustrating a chip case (100′) applicable to a chip dispenser according to another embodiment of the present invention.

Referring to FIG. 6, the chip case (100′) may include a base unit (11) and a cover unit (21) capable of being coupled to the base unit (11). The cover unit (21) may be configured to cover an open front area of the base unit (11).

According to this embodiment, the base unit (11) and the cover unit (21) may be configured to be coupled and opened and closed in a sliding manner. The cover unit (21) may be slidably coupled to the base unit (11) from above the base unit (11) in the lengthwise direction of the base unit (11). Although not shown, configurations such as guide grooves and protrusions for slidably coupling and opening and closing may be provided in the base unit (11) and the cover unit (21). In addition, in a state in which the base unit (11) is covered with the cover unit (21), a locking device (fixing device) (not shown) for fixing the coupling thereof may be provided in various ways. By way of non-limiting example, the base unit (11) may be made of ABS or Al, and the cover unit (21) may be made of transparent PC (polycarbonate). However, the materials of the base unit (11) and the cover unit (21) may be varied in various ways. In addition, the cover unit (21) may be transparent, translucent, or opaque.

The base unit (11) and the cover unit (21) may be configured to define a cylindrical accommodating area, and a plurality of chips may be accommodated in the accommodating area. A plurality of cylindrical accommodating areas may be arranged parallel to one another, for example, in a row. According to one embodiment, a plurality of first accommodating grooves (G11) parallel to each other may be provided in the base unit (11), and a plurality of second accommodating grooves (G21) parallel to each other may be provided in the cover unit (21). Each of the plurality of first accommodating grooves (G11) and a corresponding one of the plurality of second accommodating grooves (G21) may form the cylindrical accommodating area. When the chip dispenser according to the embodiment is used, the plurality of cylindrical accommodating areas may be vertically arranged. The cylindrical accommodating area may have a cylindrical shape.

The chip case (100′) may have a chip discharge port (T11) for discharging the chips and a pusher inlet (N11). Here, the pusher inlet (N11) may be an area, which may be a type of opening, into which a pusher member (210 of FIGS. 7, 8, and 9), to be described later, is inserted. The pusher inlet (N11) may communicate with a lower side region of the cylindrical accommodating area described above, and the chip discharge port (T11) may also communicate with a lower side region of the cylindrical accommodating area. As the pusher member is inserted into the pusher inlet (N11) and pushes a chip inside the chip case (100′), the chip may be discharged through the chip discharge port (T11).

According to one embodiment, the pusher inlet (N11) and the chip discharge port (T11) may be provided at a lower end of the base unit (11) or an area adjacent thereto. For example, the pusher inlet (N11) may be provided at a rear portion of the lower end of the base unit (11), and the chip discharge port (T11) may be provided at a front portion of the lower end of the base unit (11). A plurality of chip discharge ports (T11) and a plurality of corresponding pusher inlets (N11) may be provided. The chip discharge port (T11) and the pusher inlet (N11) may be disposed at positions corresponding to the lower end of the cylindrical accommodating area described above.

According to embodiments of the present invention, for example, in a state in which the base unit (11) of the chip case (100′) is laid down, a plurality of chips may be stacked, aligned, and inserted into the first accommodating grooves (G11), and after the plurality of first accommodating grooves (G11) are filled with the plurality of chips, the cover unit (21) may be closed so as to cover the open front area of the base unit (11). Accordingly, workability in chip loading can be greatly improved, and labor and time consumption can be reduced.

Additionally, various additional configurations of the chip case (100) described with reference to FIGS. 1, 2, 3, and 4 may be identically or similarly applied to the chip case (100′) of FIG. 6.

FIG. 7 illustrates a modified example of the first accommodating groove (G11) shown in FIG. 6. Referring to FIG. 7, the first accommodating groove (G11) may have a U-shape. A plurality of first accommodating grooves (G11) having the U-shape may be arranged in parallel, and a structure in which the first accommodating grooves (G11) are arranged may be implemented as an aluminum extrusion.

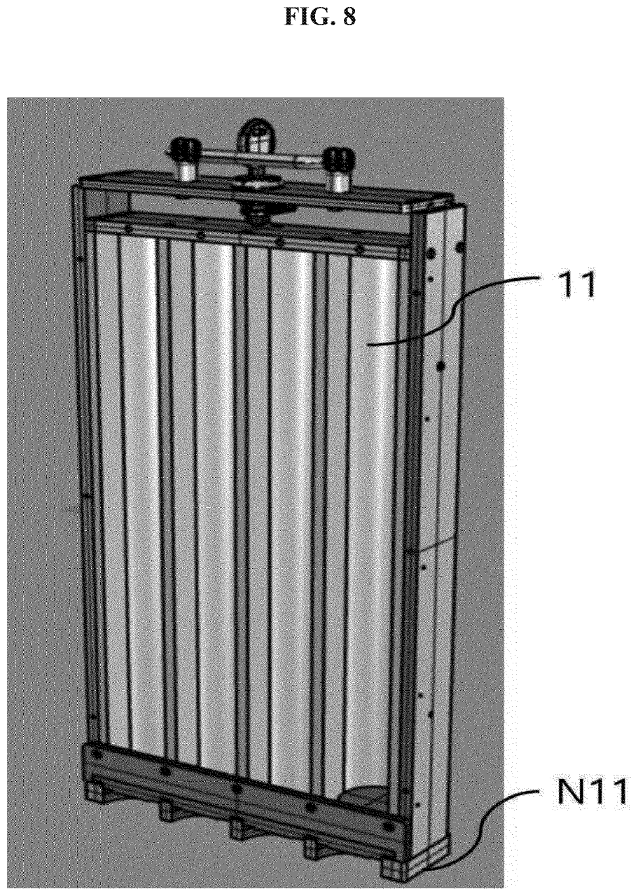

FIG. 8 is a view illustrating the base unit (11) to which the first accommodating grooves (G11) shown in FIG. 7 are applied. Referring to FIG. 8, the cover unit (21) shown in FIG. 6 may be implemented as a flat plate made of a transparent material. Also, unlike the configuration shown in FIG. 6, the cover unit (21) may open and close one side of the base unit (11) by sliding left and right.

FIGS. 9, 10, and 11 are perspective views exemplarily illustrating a dispensing device (200) applicable to a chip dispenser according to an embodiment of the present invention.

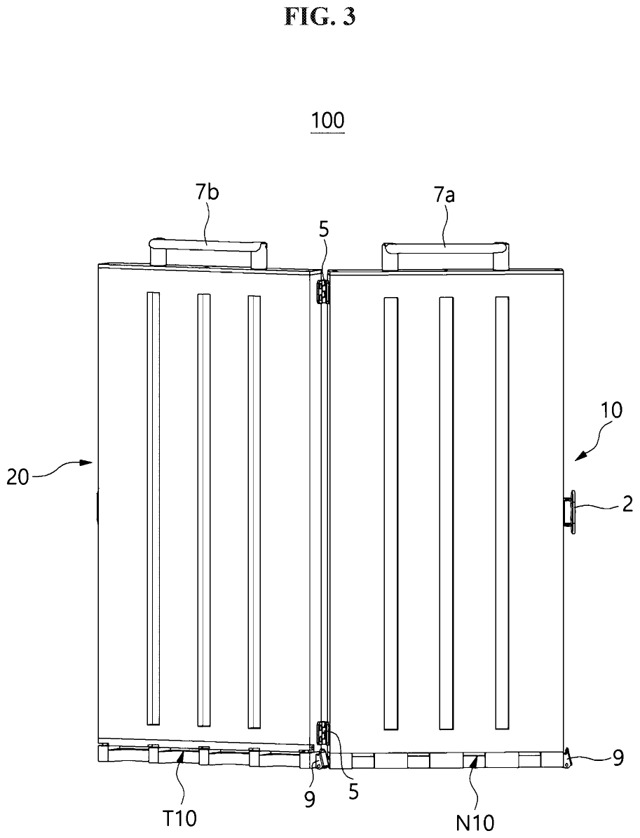

Referring to FIGS. 9, 10, and 11, the dispensing device (200) may be a device on which the chip case described with reference to FIGS. 1, 2, 3, 4, 5, 6, 7, and 8 is mounted. That is, the chip case may be mounted on the dispensing device (200). The dispensing device (200) may include a pusher member (210) capable of entering and exiting through the pusher inlet (N10 of FIG. 3 and N11 of FIG. 6) and a driving unit (220) for driving the pusher member (210). Linear reciprocating motion of the pusher member (210) may be enabled by the driving unit (220). The linear reciprocating motion of the pusher member (210) may be performed, for example, in a horizontal direction or a substantially horizontal direction. In a state in which the chip case is mounted on the dispensing device (200), the pusher member (210) may be inserted into the pusher inlet (N10 of FIG. 3 and N11 of FIG. 6) and push a chip inside the chip case so that the chip may be discharged through the chip discharge port (T10 of FIG. 3 and T11 of FIG. 6).

According to one embodiment, the driving unit (220) may be a motor member for rotating the rotation shaft member (225) or may include such a motor member. The driving unit (220) shown herein may be a motor member, and the motor member may include the rotation shaft member (225). The motor member may be disposed in a vertical direction, and the rotation shaft member (225) may be disposed to face upward. For example, a plurality of driving units (220) may be vertically arranged side by side. A plurality of driving units (220) may be provided in a number corresponding to the number of cylindrical accommodating areas included in the chip case described above. Each driving unit (220) may be provided to correspond to each cylindrical accommodating area.

According to one embodiment, the dispensing device (200) may include a power transmission structure for converting rotational motion of the rotation shaft member (225) into linear reciprocating motion of the pusher member (210). Specifically, by way of one example, the power transmission structure may include a rotation plate (230) coupled to the rotation shaft member (225) and rotated together therewith, a first strut part (235) coupled to the rotation plate (230), a second strut part (245) coupled to the pusher member (210), and a connection part (240) disposed to connect the first and second strut parts (235, 245).

The rotation plate (230) may have, for example, a circular structure. The rotation shaft member (225) may be connected to a central portion of the rotation plate (230) from below the rotation plate (230). The first strut part (235) may be connected to an edge portion of the rotation plate (230) or a region between the central portion and the edge portion, from above or laterally of the rotation plate (230). The connection part (240) may be provided above the rotation plate (230) to connect the first and second strut parts (235, 245) to each other. The connection part (240) may have a rod or bar shape. The first strut part (235) may be connected to one end of the connection part (240), and the second strut part (245) may be connected to the other end of the connection part (240). The second strut part (245) may extend upward from the connection part (240) and be connected to the pusher member (210). The first and second strut parts (235, 245) may have the form of vertical columns, that is, poles. By the power transmission structure having such a configuration, rotational motion of the rotation shaft member (225) may be converted into linear reciprocating motion of the pusher member (210). However, the specific configuration of the power transmission structure may vary depending on circumstances. For example, the method of converting rotational motion into linear reciprocating motion may also be implemented by electric or pneumatic solenoids, motors with belts and pulleys, motors with racks and pinions, and the like.

According to one embodiment, the dispensing device (200) may include a first support structure (201), a second support structure (203), and a third support structure (205). The first support structure (201) may be disposed at a lower portion of the dispensing device (200). A plurality of accommodating portions may be provided in the first support structure (201), and the driving units (220) may be received and disposed in the plurality of accommodating portions. The second support structure (203) may be an intermediate support part. The second support structure (203) may have a plate form, may be provided above the driving units (220), and may have through-holes through which the rotation shaft members (225) pass. The third support structure (205) may be disposed at an upper portion of the dispensing device (200) and may serve to support the pusher member (210) and the like.

A plurality of first support columns (202) connecting the first support structure (201) and the third support structure (205) may be provided, and a plurality of second support columns (204) connecting the second support structure (203) and the third support structure (205) may be provided. The first support structure (201), the second support structure (203), the third support structure (205), the first support columns (202), and the second support columns (204) may be regarded as constituting one “support structure.” Here, the “support structure” may also be referred to as a support frame structure or a support frame body. However, the structures, shapes, connection relationships, and the like of the first support structure (201), the second support structure (203), the third support structure (205), the first support columns (202), and the second support columns (204) are merely exemplary and may be changed in various ways.

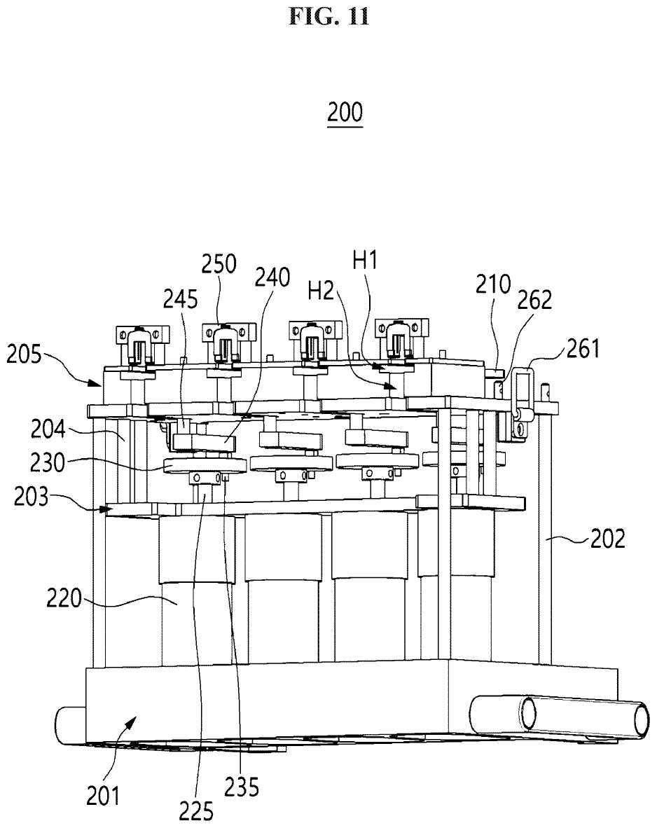

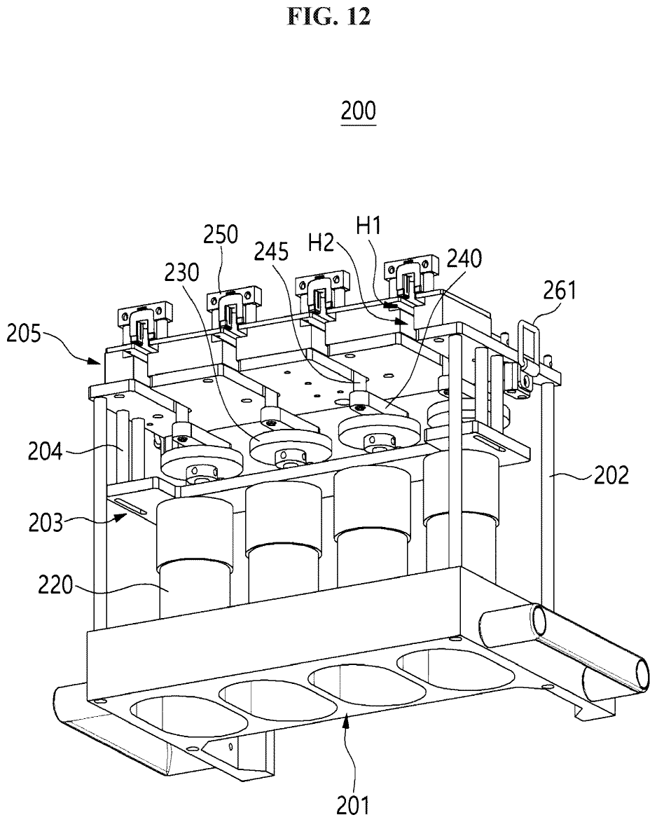

According to one embodiment, the third support structure (205) may have a first guide hole (H1) for guiding movement of the pusher member (210) and a second guide hole (H2) for guiding movement of the second strut part (245) (see FIGS. 11 and 12). The first guide hole (H1) and the second guide hole (H2) may be formed to communicate with each other. The first guide hole (H1) may have a first width, and the second guide hole (H2) may have a second width smaller than the first width. The second guide hole (H2) may be formed below a central portion of the first guide hole (H1).

The pusher member (210) may have a plate-like structure having a predetermined length and width, and a front end thereof may have a somewhat concave rounded shape reflecting the shape of the chip. The first guide hole (H1) may have a shape corresponding to the pusher member (210) so as to accommodate the pusher member (210). The first guide hole (H1) may have a horizontal hole structure. The pusher member (210) may project toward the front of the third support structure (205) or, conversely, be withdrawn according to guidance of the first guide hole (H1). In other words, the pusher member (210) may advance toward the front of the third support structure (205) or retreat according to guidance of the first guide hole (H1). Although the present drawing illustrates a case in which the pusher member (210) is projected, the pusher member (210) may be disposed within the first guide hole (H1) so as not to project toward the front of the third support structure (205).

Movement of the second strut part (245) may be guided by the second guide hole (H2). The second guide hole (H2) may be formed to extend linearly in the moving direction of the pusher member (210). Accordingly, the second strut part (245) may move linearly and reciprocate within the second guide hole (H2).

As the rotation plate (230) rotates, the position of the first strut part (235) changes, and accordingly the position of the second strut part (245) may move. For example, when the first strut part (235) rotates along a circle, the second strut part (245) may move linearly and reciprocally within the second guide hole (H2). As a result, the pusher member (210) coupled to the second strut part (245) may perform linear reciprocating motion. As the pusher member (210) performs linear reciprocating motion, chips disposed in the chip case may be discharged one by one through the chip discharge port. However, the specific operating manner and configuration described herein are exemplary and may vary depending on circumstances.

According to one embodiment, the dispensing device (200) may further include a sensor unit (250) for detecting the position of the pusher member (210). For example, the sensor unit (250) may be disposed on an upper part of the third support structure (205) and may be configured to detect the position of a rear end of the pusher member (210) or a portion adjacent thereto. A plurality of sensor units (250) may be arranged to correspond to a plurality of pusher members (210). Although not shown, the sensor unit (250) may be connected to a controller. The controller may include a control circuit or a control board. The controller may control operation of the sensor unit (250) and collect and process result data sensed by the sensor unit (250).

According to one embodiment, the dispensing device (200) may be configured such that, in a state where the pusher member (210) is detected by the sensor unit (250), the position of the pusher member (210) is moved by operation of the driving unit (220), and accordingly the pusher member (210) enters a state in which it is not detected by the sensor unit (250), and when the position of the pusher member (210) moves so that the pusher member (210) is again detected by the sensor unit (250), operation of the driving unit (220) is stopped such that one chip is discharged per cycle.

Whenever the rotation plate (230) completes one revolution and the sensor unit (250) detects the pusher member (210), the driving unit (220) may be stopped. In addition, whenever the rotation plate (230) completes one revolution, the pusher member (210) may perform one linear reciprocating motion and one chip may be discharged. For example, as the motor rotates, starting from a sensor-detected state, when the pusher member enters a sensor-undetected state, that is, a state in which the pusher member is inserted into the chip case, and then returns to a sensor-detected state, the motor may be stopped, and one chip may be discharged per such one cycle, that is, one rotation. The sensor unit (250) may be electrically or circuit wise connected to the driving unit (220), and operation of the driving unit (220) may be controlled by the sensor unit (250). The sensor unit (250) may detect the position of the driving unit (220), for example, a motor or the like. The sensor unit (250) may check whether the driving unit (220) is in a predesignated initial position before starting operation. In addition, the sensor unit (250) may check whether the driving unit (220) operates properly. The sensor unit (250) may also be used to count the number of discharged chips.

According to one embodiment, the dispensing device (200) may further include corresponding fastening members (261). By way of non-limiting example, the corresponding fastening members (261) may be provided on both side surface portions of the third support structure (205). The corresponding fastening members (261) may be fastened to the fastening members (9) described above with reference to FIGS. 1, 2, 3, and 4. Accordingly, firm fastening may be achieved between the dispensing device (200) and the chip case.

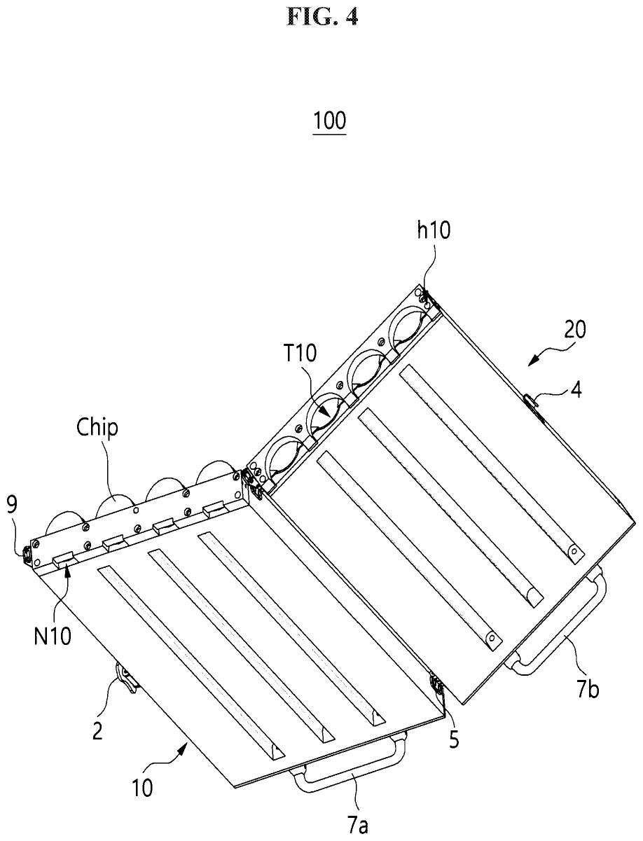

According to one embodiment, the dispensing device (200) may further include a plurality of protrusions (262). By way of non-limiting example, the plurality of protrusions (262) may be provided on an upper surface of the third support structure (205). As the protrusions (262) are inserted into the insertion holes (h10) described above with reference to FIGS. 4 and 5, alignment of the chip case and the dispensing device (200) may be facilitated. Accordingly, mounting of the chip case on the dispensing device (200) may be performed more easily.

According to embodiments of the present invention, it is possible to implement a chip dispenser capable of accurately and easily discharging chips while suppressing or minimizing damage to the chips. In the chip case, chips can be discharged directly from the chip case without a separate passage for chip discharge. In addition, chips can be quickly and accurately discharged by using the pusher member (210) of the dispensing device (200).

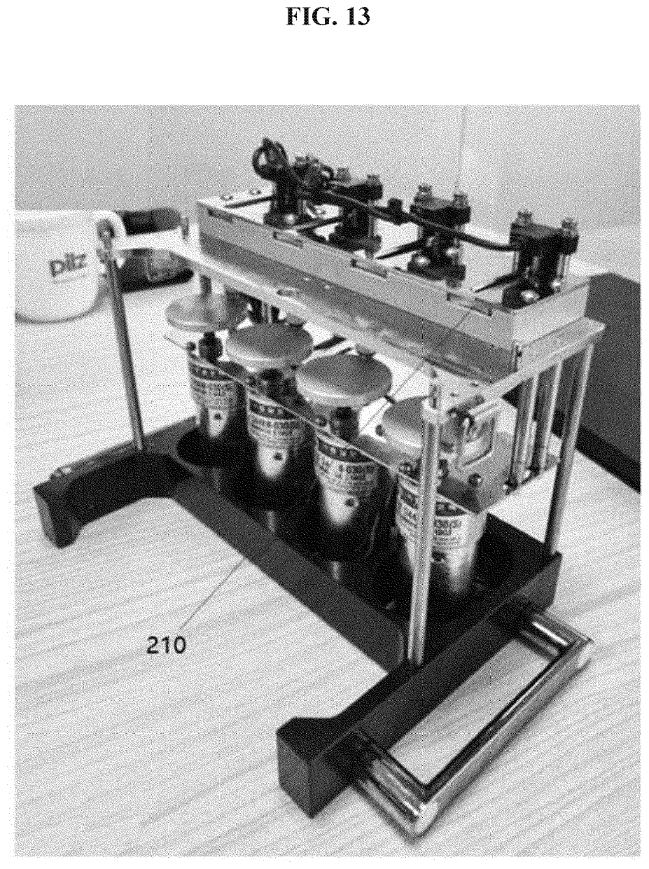

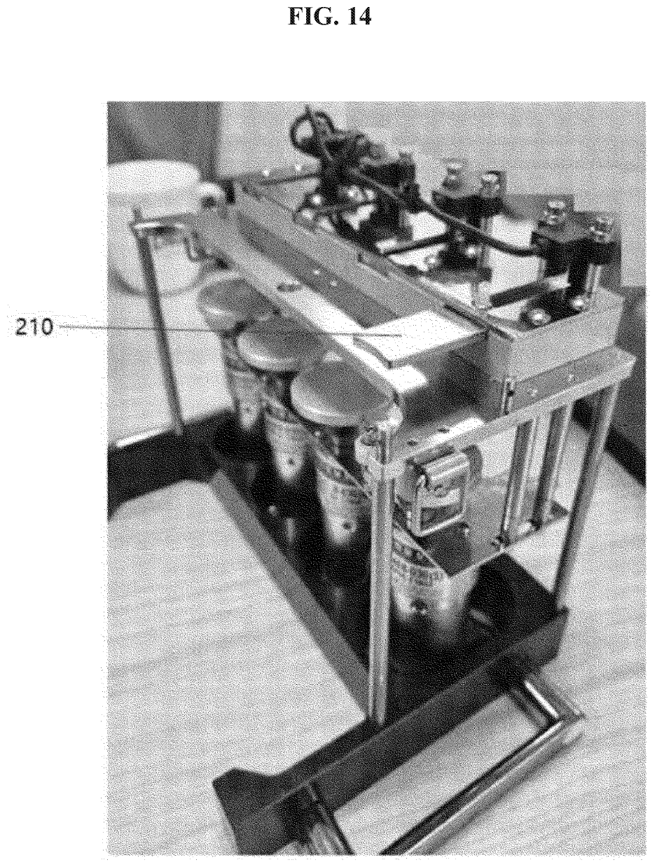

FIGS. 13 and 14 are photographic images exemplarily illustrating a dispensing device according to an embodiment of the present invention.

Referring to FIGS. 13 and 14, the dispensing device may have the configuration as described above with reference to FIGS. 9, 10, and 11. FIG. 13 shows a state in which all of the pusher members (210) are not projected, and FIG. 14 shows a state in which one of the pusher members (210) is projected.

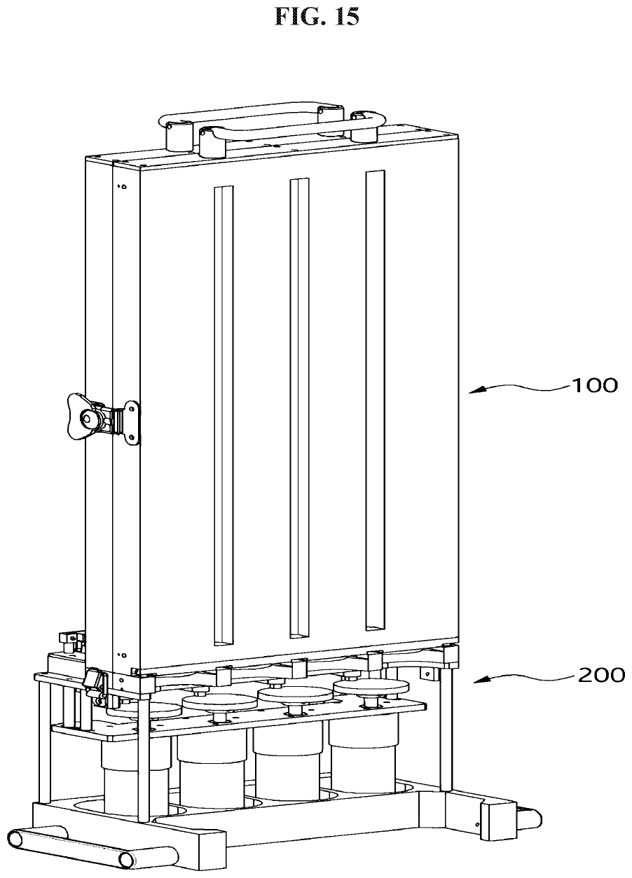

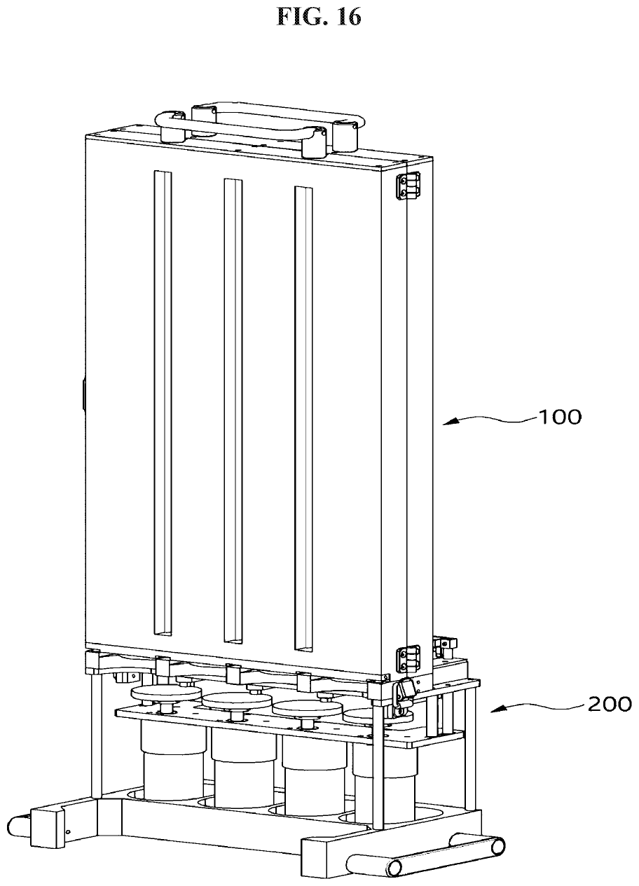

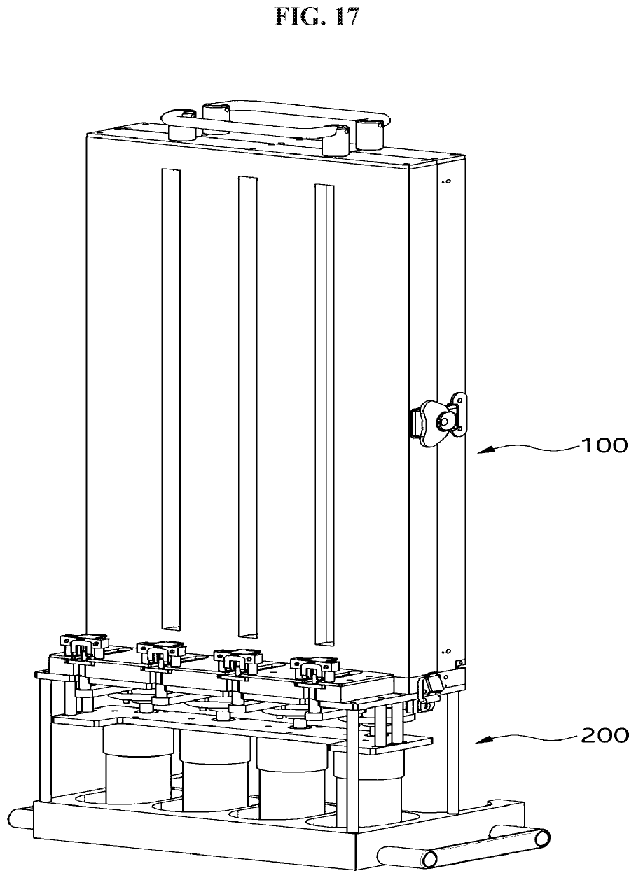

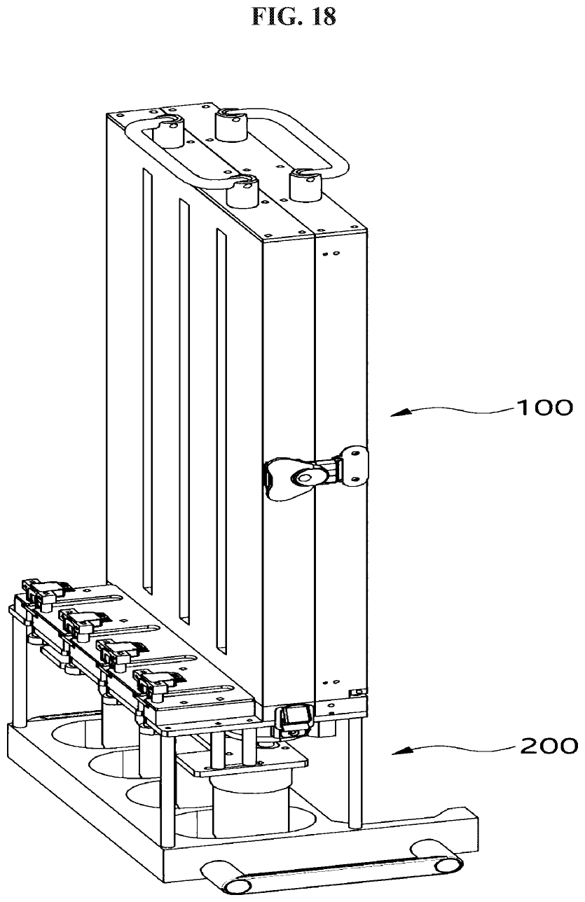

FIGS. 15, 16, 17, and 18 are perspective views exemplarily illustrating a chip dispenser including a chip case (100) and a dispensing device (200) coupled to each other according to an embodiment of the present invention.

Referring to FIGS. 15, 16, 17, and 18, the chip case (100) containing a plurality of chips may be mounted on the dispensing device (200). The chip case (100) may be vertically arranged. In this state, as described above, the chips contained in the chip case (100) may be dispensed by causing the pusher member to perform linear reciprocating motion using the driving unit of the dispensing device (200).

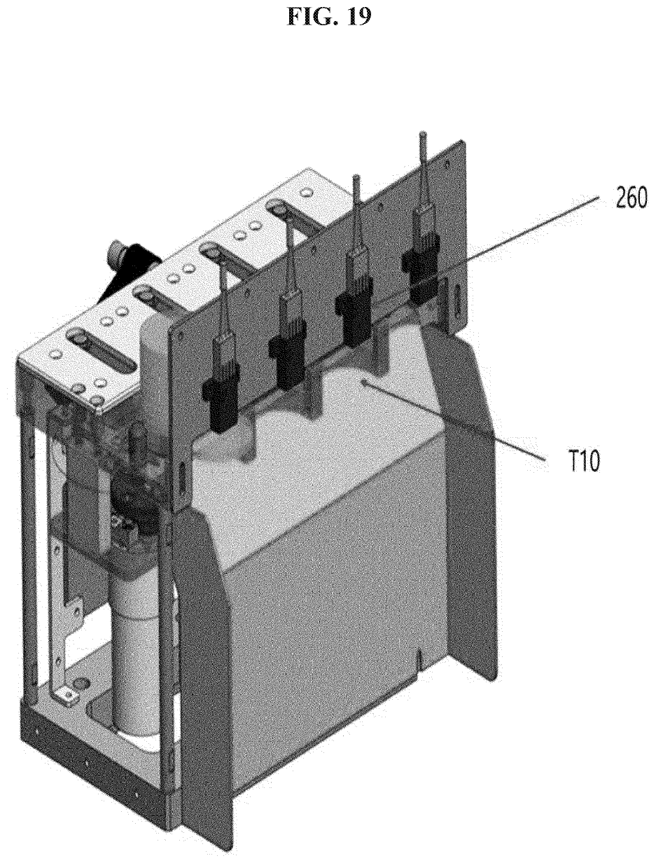

FIG. 19 is a view illustrating a discharge port sensor (260) that may be included in the dispensing device (200).

Referring to FIG. 19, the dispensing device (200) may further include a discharge port sensor (260). In a state in which the chip case (100) is coupled to the dispensing device (200), the discharge port sensor (260) may be positioned above the chip discharge port (T10) of the dispensing device (200). The discharge port sensor (260) may count the number of chips discharged from the chip discharge port (T10).

When a situation occurs in which the inside of the chip case (100) is empty or a chip is jammed at the chip discharge port (T10), the sensor unit (250) may not accurately count the number of chips discharged based on operation of the driving unit (220). The discharge port sensor (260) may detect a chip when the chip is discharged from the chip discharge port (T10) and passes below the discharge port sensor (260). Since the discharge port sensor (260) directly senses the chips discharged from the chip discharge port (T10), whether a chip has been discharged can be accurately determined even when the inside of the chip case (100) is empty or a chip is jammed at the chip discharge port (T10). An abnormal situation, such as failure of a chip to be discharged due to malfunction of the dispensing device (200), may be detected by the discharge port sensor (260).

As described above, according to embodiments of the present invention, it is possible to implement a chip dispenser capable of greatly improving workability in chip loading and reducing labor and time consumption. In addition, according to embodiments of the present invention, it is possible to implement a chip dispenser capable of accurately and easily discharging chips while suppressing or minimizing damage to the chips. Accordingly, by using the chip dispenser according to embodiments, it is possible to improve workability to reduce related costs and time, ensure accurate dispensing operation, and further reduce maintenance costs.

In the present specification, preferred embodiments of the present invention have been disclosed, and although specific terms have been used, they are used only in a general sense for easily explaining the technical contents of the present invention and helping understanding of the invention, and are not intended to limit the scope of the present invention. It will be apparent to those skilled in the art that, in addition to the embodiments disclosed herein, other modified embodiments based on the technical spirit of the present invention may be practiced. For example, those skilled in the art will appreciate that the chip dispenser and method of operating the same according to the embodiments described with reference to FIGS. 1 to 19 may be modified in various ways. Accordingly, the scope of the invention should not be defined by the described embodiments but should be defined by the technical spirit set forth in the appended claims.

### LIST OF REFERENCE NUMERALS

2: fastening element 4: corresponding fastening element
5: hinge member 7a, 7b: handle unit
9: fastening member 10, 11: base unit
20, 21: cover unit 100: chip case
100′: chip case G10, G11: first accommodating groove
G20, G21: second accommodating groove h10: insertion hole
H1: first guide hole H2: second guide hole
N10, N11: pusher inlet T10, T11: chip discharge port
200: dispensing device 210: pusher member
220: driving unit 225: rotation shaft member
235: first strut part 240: connection part
245: second strut part 250: sensor unit
261: corresponding fastening member 262: protrusion

What is claimed is:

1. A chip dispenser for dispensing chips, comprising:
a chip case including a base unit and a cover unit capable of being coupled to the base unit, wherein the base unit and the cover unit are configured to define a cylindrical accommodating area, a plurality of chips are accommodated within the accommodating area, a chip discharge port for discharging chip and a pusher inlet; and
a dispensing device on which the chip case is mounted, comprising a pusher member capable of entering the pusher inlet and a driving unit for driving the pusher member, wherein the driving unit is configured to enable linear reciprocating motion of the pusher member;
wherein, in a state where the chip case is mounted on the dispensing device, the pusher member is inserted into the pusher inlet and pushes the chip inside the chip case, thereby discharging the chip through the chip discharge port.

2. The chip dispenser of claim 1,
wherein a hinge member is provided between the base unit and the cover unit,
the base unit and the cover unit are configured to be opened and closed in a pivoting manner by the hinge member.

3. The chip dispenser of claim 1,
wherein the base unit and the cover unit are configured to be coupled and to be opened and closed in a sliding manner.

4. The chip dispenser of claim 1,
wherein the pusher inlet is provided at a lower end of any one of the base unit and the cover unit,
the chip discharge port is provided at a lower end of the other one of the base unit and the cover unit.

5. The chip dispenser of claim 1,
wherein the pusher inlet and the chip discharge port are provided at a lower end of the base unit.

6. The chip dispenser of claim 1,
wherein a plurality of first accommodating grooves parallel to each other are provided in the base unit,
a plurality of second accommodating grooves parallel to each other are provided in the cover unit,
the cylindrical accommodating area is formed by the first accommodating groove and the second accommodating groove corresponding to the first accommodating groove.

7. The chip dispenser of claim 1,
wherein the cover unit is configured to cover an open front area of the base unit.

8. The chip dispenser of claim 1,
wherein the driving unit includes a motor member for rotating a rotation shaft member,
the dispensing device includes a power transmission structure for converting rotational motion of the rotation shaft member into linear reciprocating motion of the pusher member.

9. The chip dispenser of claim 8, wherein the power transmission structure includes:
a rotation plate coupled to the rotation shaft member to be rotated together therewith;
a first strut part coupled to the rotation plate;
a second strut part coupled to the pusher member; and
a connection part disposed to connect the first and second strut parts.

10. The chip dispenser of claim 9,
wherein the dispensing device includes a support structure,
the support structure is provided with a first guide hole for guiding movement of the pusher member and a second guide hole for guiding movement of the second strut part.

11. The chip dispenser of claim 1,
wherein the dispensing device further includes a sensor unit for detecting a position of the pusher member.

12. The chip dispenser of claim 11,
wherein the chip dispenser is configured such that one chip is discharged per cycle in which, in a state where the pusher member is detected by the sensor unit, the position of the pusher member is moved by driving of the driving unit, and accordingly, the pusher member enters an undetected state by the sensor unit, when the position of the pusher member is moved to again enter a detected state by the sensor unit, the driving of the driving unit is stopped.
